(19) United States
(12) Patent Application Publication
(10) Pub. No.: US 2010/0217804 A1
(43) Pub. Date: Aug. 26, 2010

(54) Collaborative draft forum-messages

(75) Inventors: Marco Carrer, Reading, MA (US); Gopalan Arun, Saratoga, CA (US); David Mor, Merrimack, NH (US); Amanda Smith, Nashua, NH (US)

Correspondence Address: Kraguljac & Kalnay, LLC - Oracle, 4700 Rockside Road, Summit One, Suite 510, Independence, OH, 44131, US

(73) Assignee: ORACLE INTERNATIONAL CORPORATION, REDWOOD SHORES, CA (US)

(21) Appl. No.: 12/380,048

(22) Filed: Feb. 23, 2009

(51) Int. Cl. G06F 15/16; G06F 17/30

(52) U.S. Cl. 709/206; 707/E17.009

(57) ABSTRACT

Systems, methods, and other embodiments associated with collaborative draft forum-messages are described. One example method includes receiving draft forum-message data from a drafter. The draft forum-message data may identify a set of entities to whom the drafter seeks to grant edit privileges. The example method may also include providing a portion of the draft forum-message data to one of the identified entities and allowing them to view and/or modify the draft forum-message data.

### BACKGROUND

One type of software that has become popular for asynchronous online communications is the discussion forum application. Conventional discussion forum applications, also known as web forums and bulletin boards, allow users to initiate a topic of discussion by creating a topic post, also known as a thread, in which other users may respond by creating reply posts. A thread allows multiple users to have a conversation on a topic, leaving a history of the conversation for other users to view. This history allows a new or returning user to review the thread to catch up with a conversation that may have been taking place while the user was not able to participate in the discussion. Some businesses have started using discussion forums as a way to facilitate internal discussions and as a knowledgebase. Some businesses may also use discussion forums externally as customer support and customer relations tools.

Because businesses often have a chain of command and/or an approval process for storing and/or publishing information, some employees who author drafts may have to go through a review process before what they have written can be published. Currently, this may require a secondary application, such as an email application, where a preliminary version is sent to a superior for authorization. However, this may be inefficient as it may be difficult to provide version control in a secondary application. Further, secondary applications may not facilitate a robust and modular review of a forum-message when many people are involved in the review of a forum-message.

### BRIEF DESCRIPTION OF THE DRAWINGS

The accompanying drawings, which are incorporated in and constitute a part of the specification, illustrate various example systems, methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 illustrates an example method associated with collaborative draft forum-messages.

FIG. 2 illustrates an example method associated with collaborative draft forum-messages.

FIG. 3 illustrates an example method associated with collaborative draft forum-messages.

FIG. 4 illustrates an example method associated with collaborative draft forum-messages.

FIG. 5 illustrates an example system associated with collaborative draft forum-messages.

FIG. 6 illustrates an example computing environment in which example systems and methods, and equivalents, may operate.

### DETAILED DESCRIPTION

For users to reap the full benefits of a discussion forum application, they often find that they must be active participants in the forums. Participating in the forum allows users to contribute to existing topics or start new topics of interest to them that have not yet been satisfactorily addressed. In a corporate environment, where posts focus on work-related topics, users tend to compose more complex posts. These posts take more time to compose and often require several editing iterations, possibly by more than one user, that may involve a review and approval process.

Discussion forums presently do not support collaborative draft forum-messages. This may be due to the complexity of supporting drafts for various types of forum-messages. Types of forum-messages may include replies, new topics, and announcements (which include activation and expiration dates). In addition, since discussion forums are collaborative by nature, it would be beneficial for multiple users to be able to collaborate on the draft forum-message, thereby enabling a review/approval process of discussion drafts prior to their posting.

To accurately model drafts in a discussion forum application, the draft forum-message may save the message subject and body as well as the destination of the draft, which is where the draft will be posted. For example, in the case of discussion draft for a reply to a post, the final destination for the draft forum-message indicates the messages' intended parent message in an existing topic. If the draft is for a new topic or announcement, the destination would be a specific discussion forum. The draft reply, topic, or announcement may include several messages that are threaded together, possibly composed in a collaborative manner by different users. In this case, upon posting the draft forum-message, the entire set of messages and their replies may be posted to the correct location.

Systems and methods associated with collaborative draft forum-messages are disclosed. One example method comprises receiving draft forum-message data that identifies a set of collaborators. The draft forum-message data may then be stored in a data store and access to the data may be granted to the collaborators. Thus, an external application (e.g., an email application) may not be necessary for review and/or approval of draft forum-messages. Additionally, as draft forum-message data may include metadata, publishing a finalized non-draft forum-message may be faster than importing information from an external application. Further, draft forum-message data may be stored in a data store associated with a forum application on which the draft forum-message data may finally be posted. This may allow the draft forum-message data to include formatting information including font information, hyperlink information, imbedded images, and so on. Thus, collaborators may preview and/or modify a draft using the syntax that is used for published non-draft forum-messages.

In one example, draft forum-message data may be stored in a database table that also stores non-draft forum-message data. Thus, an attribute (e.g., a value in a column) may be used to distinguish between draft forum-message data and non-draft forum-message data. In another example, draft forum-message data may be stored separately from non-draft forum-message data in a second database table. However, a person having ordinary skill in the art can see how it may be advantageous to use a greater number of tables in some instances.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

ASIC: application specific integrated circuit.

CD: compact disk.

CD-R: CD recordable.

CD-RW: CD rewriteable.

DVD: digital versatile disk and/or digital video disk.

HTTP: hypertext transfer protocol.

LAN: local area network.

PCI: peripheral component interconnect.

PCIE: PCI express.

RAM: random access memory.

DRAM: dynamic RAM.

SRAM: static RAM.

ROM: read only memory.

PROM: programmable ROM.

SQL: structured query language.

OQL: object query language.

USB: universal serial bus.

XML: extensible markup language.

WAN: wide area network.

“Computer component”, as used herein, refers to a computer-related entity (e.g., hardware, firmware, software in execution, combinations thereof). Computer components may include, for example, a process running on a processor, a processor, an object, an executable, a thread of execution, and a computer. A computer component(s) may reside within a process and/or thread. A computer component may be localized on one computer and/or may be distributed between multiple computers.

“Computer communication”, as used herein, refers to a communication between computing devices (e.g., computer, personal digital assistant, cellular telephone) and can be, for example, a network transfer, a file transfer, an applet transfer, an email, an HTTP transfer, and so on. A computer communication can occur across, for example, a wireless system (e.g., IEEE 802.11), an Ethernet system (e.g., IEEE 802.3), a token ring system (e.g., IEEE 802.5), a LAN, a WAN, a point-to-point system, a circuit switching system, a packet switching system, and so on.

“Computer-readable medium”, as used herein, refers to a medium that stores signals, instructions and/or data. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an ASIC, a CD, other optical medium, a RAM, a ROM, a memory chip or card, a memory stick, and other media from which a computer, a processor or other electronic device can read.

In some examples, “database” is used to refer to a table. In other examples, “database” may be used to refer to a set of tables. In still other examples, “database” may refer to a set of data stores and methods for accessing and/or manipulating those data stores.

“Data store”, as used herein, refers to a physical and/or logical entity that can store data. A data store may be, for example, a database, a table, a file, a data structure (e.g. a list, a queue, a heap, a tree) a memory, a register, and so on. In different examples, a data store may reside in one logical and/or physical entity and/or may be distributed between two or more logical and/or physical entities.

“Logic”, as used herein, includes but is not limited to hardware, firmware, software in execution on a machine, and/or combinations of each to perform a function(s) or an action(s), and/or to cause a function or action from another logic, method, and/or system. Logic may include a software controlled microprocessor, a discrete logic (e.g., ASIC), an analog circuit, a digital circuit, a programmed logic device, a memory device containing instructions, and so on. Logic may include one or more gates, combinations of gates, or other circuit components. Where multiple logical logics are described, it may be possible to incorporate the multiple logical logics into one physical logic. Similarly, where a single logical logic is described, it may be possible to distribute that single logical logic between multiple physical logics.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, software). Logical and/or physical communication channels can be used to create an operable connection.

“Query”, as used herein, refers to a semantic construction that facilitates gathering and processing information. A query may be formulated in a database query language (e.g., SQL), an OQL, a natural language, and so on.

“Signal”, as used herein, includes but is not limited to, electrical signals, optical signals, analog signals, digital signals, data, computer instructions, processor instructions, messages, a bit, a bit stream, and so on, that can be received, transmitted and/or detected.

“Software”, as used herein, includes but is not limited to, one or more executable instruction that cause a computer, processor, or other electronic device to perform functions, actions and/or behave in a desired manner. “Software” does not refer to stored instructions being claimed as stored instructions per se (e.g., a program listing). The instructions may be embodied in various forms including routines, algorithms, modules, methods, threads, and/or programs including separate applications or code from dynamically linked libraries.

“User”, as used herein, includes but is not limited to one or more persons, software, logics, computers or other devices, or combinations of these.

The terms “contain”, “store”, and so on, as employed herein (e.g., a data store to store a value, a signal containing a datum), are not intended to limit a storing element or a containing element to directly hold a stored element or a contained element. A storing element may hold an identifier (e.g., a pointer, a reference, a handle) that indicates a location of a stored element. A storing element may also hold an identifier that indicates a location of a data structure that holds the stored element.

Some portions of the detailed descriptions that follow are presented in terms of algorithms and symbolic representations of operations on data bits within a memory. These algorithmic descriptions and representations are used by those skilled in the art to convey the substance of their work to others. An algorithm, here and generally, is conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic, and so on. The physical manipulations create a concrete, tangible, useful, real-world result.

It has proven convenient at times, principally for reasons of common usage, to refer to these signals as bits, values, elements, symbols, characters, terms, numbers, and so on. It should be borne in mind, however, that these and similar terms are to be associated with the appropriate physical quantities and are merely convenient labels applied to these quantities. Unless specifically stated otherwise, it is to be appreciated that throughout the description, terms including processing, computing, determining, and so on, refer to actions and processes of a computer system, logic, processor, or similar electronic device that manipulates and transforms data represented as physical (electronic) quantities.

Example methods may be better appreciated with reference to flow diagrams. For purposes of simplicity of explanation, the illustrated methodologies are shown and described as a series of blocks. However, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks.

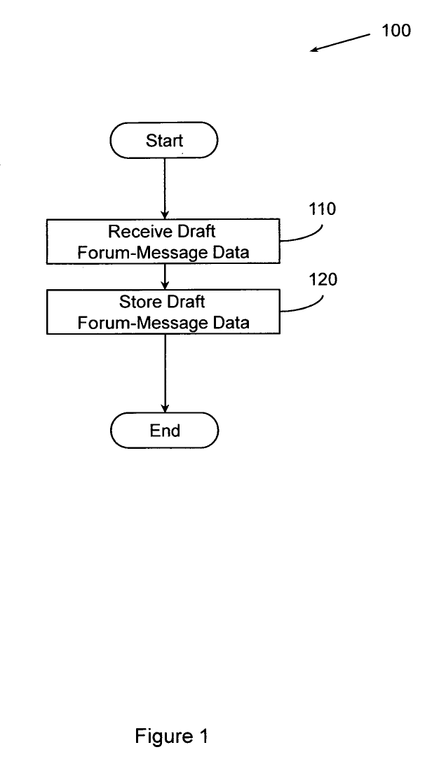

FIG. 1 illustrates an embodiment of a method 100 associated with collaborative draft forum-messages. Method 100 includes, at 110, receiving draft forum-message data. The draft forum-message data may be received from a drafting entity. The drafting entity may be a user or a logic. For example, draft forum-message data may be received from a logic configured to generate a draft forum-message from a template on a set schedule. By way of illustration a calendar logic may generate a meeting reminder forum-message once a week that may be lacking topic information. The topic information may be filled in before the reminder is published. The draft forum-message data may include a draft forum-message. The draft forum-message data may also include a set of collaborating entities to whom the drafting entity seeks to grant edit privileges. In one embodiment, the drafting entity may be automatically included in the set of collaborating entities.

Method 100 also includes, at 120, storing the draft forum-message data in a data store. The data store may be a database, a table, a row, a file, and so on. Storing the draft forum-message data may include storing forum-message metadata. Forum-message metadata may include destination data, message type data, options data, subject data, and so on. Destination data may describe an intended destination for the draft forum-message. Thus, if the draft forum-message is intended to be a new topic, the location data may identify a sub-forum in which the draft forum-message may eventually be published. However, if the draft forum-message is intended to be a reply to a topic, the location data may identify the topic to which the draft forum-message replies.

Message type data may describe an intended type for the draft forum-message. Typical forums may include many different types of messages (e.g., sticky, announcement, global announcement, poll, and so on) that are treated differently by a forum application. Options data may describe intended state data for a set of options that configure the draft forum-message. The set of options may include disabling a forum functionality and enabling a forum functionality in addition to other options. For example, some forums utilize bulletin board code (bbcode) as a way to allow users to format text, insert images, and implement other features on the forums without allowing users to directly embed html. A user drafting a message illustrating the proper syntax for certain of these functions may wish to disable bbcode for their post so that the syntax doesn't get interpreted by the forum application. Subject data may describe an intended subject for the draft forum-message. A subject for a forum-message may provide a brief description about the topic of discussion of a thread. While four types of metadata are described, a person having ordinary skill in the art can see how other pieces of forum-message metadata may also be stored.

While FIG. 100 illustrates various actions occurring in serial, it is to be appreciated that various actions illustrated in FIG. 100 could occur substantially in parallel. By way of illustration, a first process could receive draft forum-message data, and a second process could store the draft forum-message data. While two processes are described, it is to be appreciated that a greater and/or lesser number of processes could be employed and that lightweight processes, regular processes, threads, and other approaches could be employed.

In one example, a method may be implemented as computer executable instructions. Thus, in one example, a computer-readable medium may store computer executable instructions that if executed by a machine (e.g., processor) cause the machine to perform a method. While executable instructions associated with the above method are described as being stored on a computer-readable medium, it is to be appreciated that executable instructions associated with other example methods described herein may also be stored on a computer-readable medium.

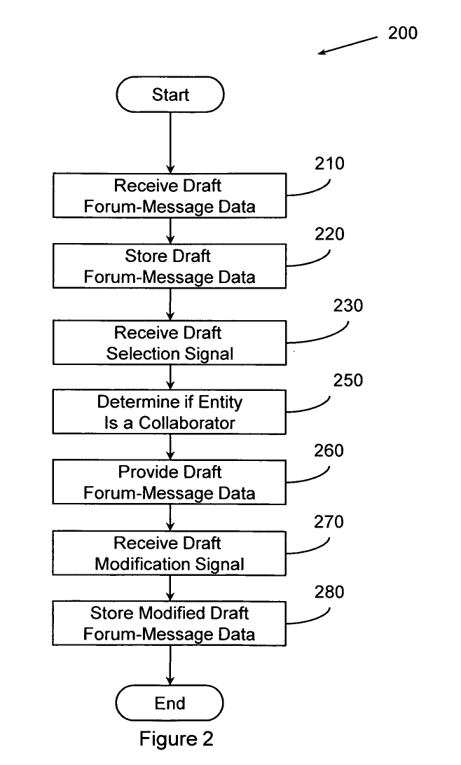

FIG. 2 illustrates an embodiment of a method 200 associated with collaborative draft forum-messages. Method 200 includes several actions similar to those described in connection with method 100 (FIG. 1). For example, method 200 includes receiving draft forum-message data at 210, and storing data at 220. However, method 200 includes additional actions.

Method 200 includes, at 230, receiving a draft selection signal. The draft selection signal may be received from a requesting entity. The draft selection signal may identify a draft forum-message in the data store. Method 200 includes, at 250, analyzing the draft forum-message data to determine if the requesting entity is identified as a collaborating entity. Method 200 also includes, at 260, providing a portion of the draft forum-message data to the requesting entity if the requesting entity is determined to be a collaborating entity having edit privileges for the draft forum-message data.

Method 200 also includes, at 270, receiving a draft modification signal from the requesting entity. The draft modification signal may identify modified draft forum-message data. Method 200 also includes, at 280, storing the modified draft forum-message data in the data store. Receiving the draft modification signal and storing the modified draft forum-message data are described in greater detail below. Thus, method 200 describes storing a draft forum-message in a data store at the request of a drafting entity, providing a requesting entity a portion of the draft forum-message upon determining that the draft forum-message identifies the requesting entity as having access to the draft forum-message, and storing a modification to the draft forum-message received from the requesting entity.

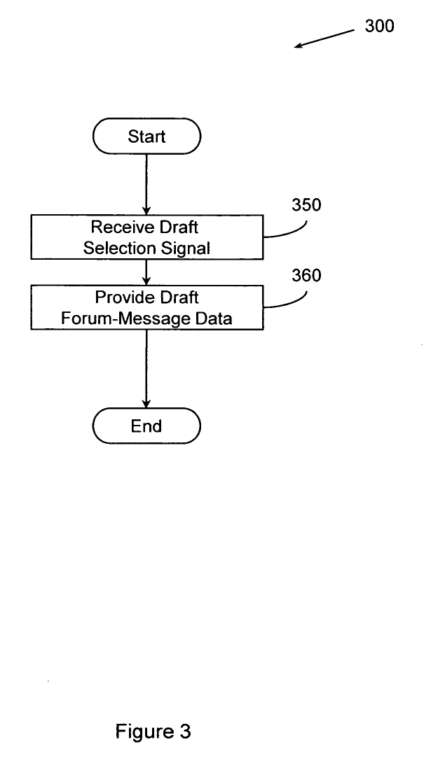

FIG. 3 illustrates an embodiment of a method 300 associated with collaborative draft forum-messages. Method 300 includes, at 350, receiving a draft selection signal. The draft selection signal may be received from a requesting entity. The draft selection signal may identify a draft forum-message in a data store. In one example, the draft selection signal may indicate that the selecting entity is seeking to view and/or modify the identified draft forum-message data.

Method 300 also includes providing a portion of the draft forum-message data to the requesting entity. The portion may be provided upon determining that the set of draft forum-message data identifies the requesting entity as a collaborating entity having edit privileges for the draft forum-message data.

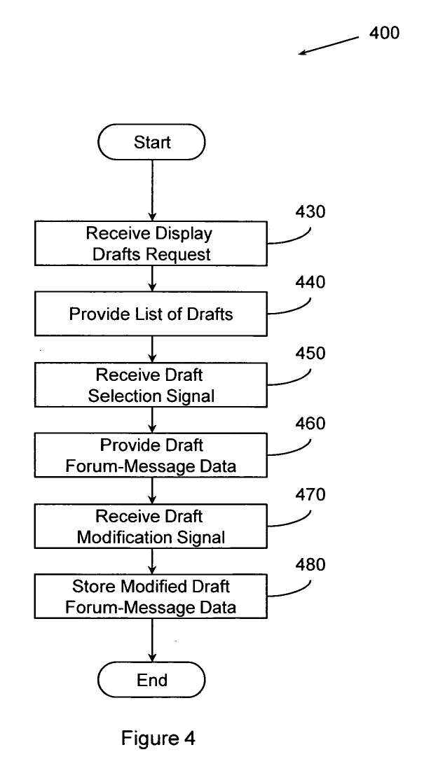

FIG. 4 illustrates a method 400 associated with collaborative draft forum-messages. Method 400 includes several actions similar to those described in connection with method 300 (FIG. 3). For example, method 400 includes receiving a draft selection signal at 450, and providing draft forum-message data at 460. However, method 400 includes additional actions

Method 400 includes, at 430, receiving a display drafts request from the requesting entity. The display drafts request may indicate that the requesting entity seeks information regarding draft forum-message data that identify the requesting entity as a collaborating entity. Method 400 also includes, at 440, providing the requesting entity a list of draft forum-message data. The list of draft forum-message data may identify draft forum-message data that identify the requesting entity as a collaborating entity having edit privileges. This list may be generated so that draft forum-message data are associated with links. If selected, a link may automatically generate a draft selection signal that identifies draft forum-message data with which the link is associated.

Method 400 also includes, at 470, receiving a draft modification signal from the requesting entity. The draft selection signal may identify modified draft forum-message data. Method 400 also includes, at 480, storing the modified draft forum-message data in the data store. In one example, storing the modified draft forum-message data may include replacing the draft forum-message data in the data store. In another example, storing the modified draft forum-message data may include storing the modified draft forum-message data as a new record in the data store. This example may facilitate version control of drafts.

Some example methods may also include receiving a draft reply signal. The draft reply signal may identify a draft forum-message. The draft reply signal may contain data comprising a draft reply that may reply to content in the draft forum-message. Thus, some example methods may include storing a draft reply in the data store. Some example methods may also facilitate publishing draft forum-messages to a live forum allowing non-collaborators to view and/or reply to the content of the forum message, thereby making it no longer a draft. These methods may include receiving a publish signal. The publish signal may request that a draft forum-message be published to an active forum. In response to receiving the publish signal, these methods may also include posting the draft forum-message to an active forum. Posting the draft forum message may include publishing the draft forum-message and/or a reply to the draft forum message. The content published may be based on an instruction in the publish signal. Thus, some methods may facilitate storing collaborative replies to a draft forum message as part of a draft thread. These methods may also facilitate the optional publishing the collaborative replies to the draft forum message when the draft forum message is posted.

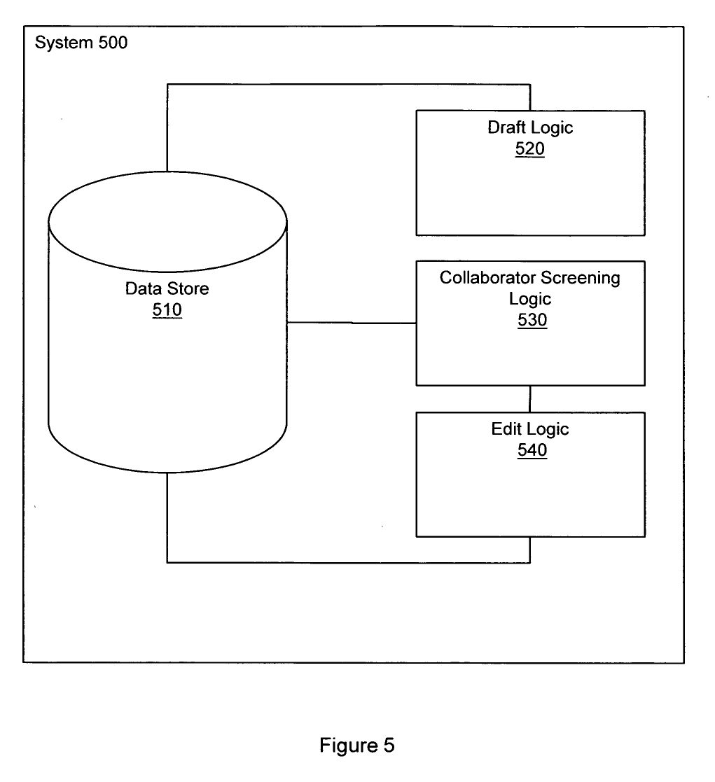

FIG. 5 illustrates a system 500 associated with collaborative draft forum-messages. System 500 includes a draft logic 520, a collaborator screening logic 530, and an edit logic 540 that access a data store 510 to store draft forum-message data. Draft forum-message data may comprise a draft forum-message and a set of collaborating entities identified as having edit privileges. Draft forum-message data may also comprise forum-message metadata. As described above, forum-message metadata may comprise one or more of, destination data, message type data, options data, subject data, and so on. Draft forum-message data may also comprise poll data. Data store 510 may be a database, a database table, a file, a linked list, and so on. In one example, data store 510 may be a table in a database that also stores sets of non-draft forum-message data. In this example, the database table may include an attribute that identifies a set of forum-message data as a set of draft forum-message data. System 500 also includes a draft logic 520. Draft logic 520 may store draft forum-message data from a drafting entity in the data store.

System 500 also includes a collaborator screening logic 530. Collaborator screening logic 530 may determine if a requesting entity seeking to access a requested draft forum-message has been identified as a collaborating entity for the draft forum-message. Collaborator screening logic 530 may make this determination by examining a portion of draft forum-message data that includes the requested draft forum-message. System 500 also includes an edit logic 540. Edit logic 540 may provide a portion of the second set of draft forum-message data to a requesting entity that has been determined to be a collaborating entity by collaborator screening logic 530.

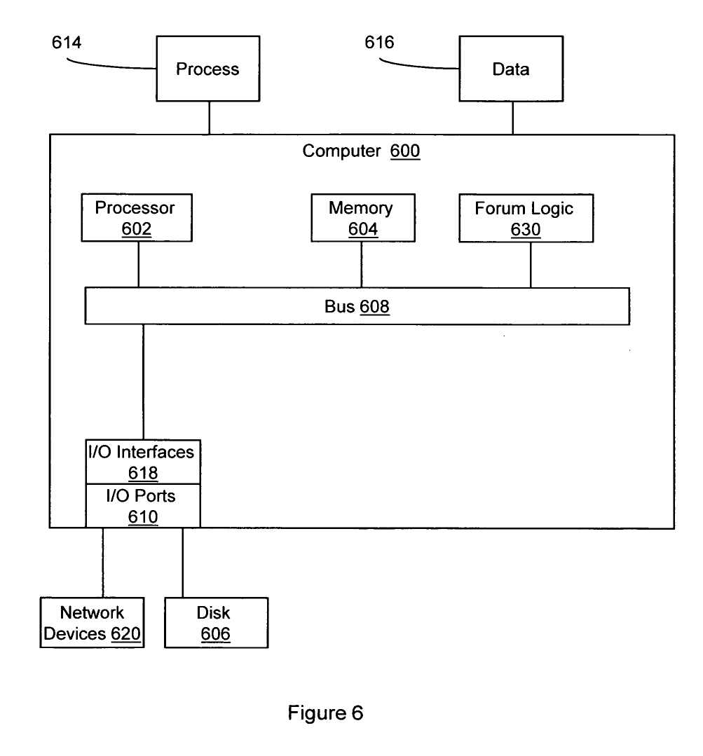

FIG. 6 illustrates an example computing device in which example systems and methods described herein, and equivalents, may operate. The example computing device may be a computer 600 that includes a processor 602, a memory 604, and input/output ports 610 operably connected by a bus 608. In one example, the computer 600 may include a forum logic 630. In different examples, forum logic 630 may be implemented in hardware, software, firmware, and/or combinations thereof. While the logic 630 is illustrated as a hardware component attached to the bus 608, it is to be appreciated that in one example, the logic 630 could be implemented in the processor 602.

Thus, logic 630 may provide means (e.g., hardware, software, firmware) for storing draft forum-message data received from a drafting entity. The draft forum-message data may include a draft forum-message and a set of entities to whom the drafting entity seeks to grant edit privileges. Logic 630 may also provide means (e.g., hardware, software firmware) for providing a portion of a requested draft forum-message to an editing entity. The portion may be provided upon determining that the draft forum-message data that includes the requested draft forum-message identifies the editing entity as having edit privileges for the second set of draft forum-message data. The means associated with logic 630 may be implemented, for example, as an ASIC. The means may also be implemented as computer executable instructions that are presented to computer 600 as data 616 that are temporarily stored in memory 604 and then executed by processor 602.

Generally describing an example configuration of the computer 600, the processor 602 may be a variety of various processors including dual microprocessor and other multi-processor architectures. A memory 604 may include volatile memory and/or non-volatile memory. Non-volatile memory may include, for example, ROM, PROM, and so on. Volatile memory may include, for example, RAM, SRAM, DRAM, and so on.

A disk 606 may be operably connected to the computer 600 via, for example, an input/output interface (e.g., card, device) 618 and an input/output port 610. The disk 606 may be, for example, a magnetic disk drive, a solid state disk drive, a floppy disk drive, a tape drive, a Zip drive, a flash memory card, a memory stick, and so on. Furthermore, the disk 606 may be a CD-ROM drive, a CD-R drive, a CD-RW drive, a DVD ROM drive, a Blu-Ray drive, an HD-DVD drive, and so on. The memory 604 can store a process 614 and/or a data 616, for example. The disk 606 and/or the memory 604 can store an operating system that controls and allocates resources of the computer 600.

The bus 608 may be a single internal bus interconnect architecture and/or other bus or mesh architectures. While a single bus is illustrated, it is to be appreciated that the computer 600 may communicate with various devices, logics, and peripherals using other busses (e.g., PCIE, 1394, USB, Ethernet). The bus 608 can be types including, for example, a memory bus, a memory controller, a peripheral bus, an external bus, a crossbar switch, and/or a local bus.

The computer 600 may interact with input/output devices via the i/o interfaces 618 and the input/output ports 610. Input/output devices may be, for example, a keyboard, a microphone, a pointing and selection device, cameras, video cards, displays, the disk 606, the network devices 620, and so on. The input/output ports 610 may include, for example, serial ports, parallel ports, and USB ports.

The computer 600 can operate in a network environment and thus may be connected to the network devices 620 via the i/o interfaces 618, and/or the i/o ports 610. Through the network devices 620, the computer 600 may interact with a network. Through the network, the computer 600 may be logically connected to remote computers. Networks with which the computer 600 may interact include, but are not limited to, a LAN, a WAN, and other networks.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Therefore, the invention is not limited to the specific details, the representative apparatus, and illustrative examples shown and described. Thus, this application is intended to embrace alterations, modifications, and variations that fall within the scope of the appended claims.

To the extent that the term “includes” or “including” is employed in the detailed description or the claims, it is intended to be inclusive in a manner similar to the term “comprising” as that term is interpreted when employed as a transitional word in a claim.

To the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

To the extent that the phrase “one or more of, A, B, and C” is employed herein, (e.g., a data store configured to store one or more of, A, B, and C) it is intended to convey the set of possibilities A, B, C, AB, AC, BC, ABC, AAA, AAB, AABB, AABBC, AABBCC, and so on (e.g., the data store may store only A, only B, only C, A&B, A&C, B&C, A&B&C, A&A&A, A&A&B, A&A&B&B, A&A&B&B&C, A&A&B&B&C&C, and so on). It is not intended to require one of A, one of B, and one of C. When the applicants intend to indicate “at least one of A, at least one of B, and at least one of C”, then the phrasing “at least one of A, at least one of B, and at least one of C” will be employed.

What is claimed is:

1. A computer-readable medium storing computer-executable instructions that when executed by a computer cause the computer to perform a method, the method comprising:
receiving draft forum-message data from a drafting entity, the draft forum-message data comprising a draft forum-message, and a set of collaborator identifiers that identify collaborating entities to whom the drafting entity seeks to grant edit privileges for the draft forum-message; and
storing the draft forum-message data in a data store.

2. The computer-readable medium of claim 1 where storing the draft forum-message data comprises storing forum-message metadata.

3. The computer-readable medium of claim 2 where storing the forum-message metadata comprises storing destination data describing an intended destination for the draft forum-message.

4. The computer-readable medium of claim 2 where storing the forum-message metadata comprises storing message type data describing an intended type for the draft forum-message.

5. The computer-readable medium of claim 2 where storing the forum-message metadata comprises storing options data describing intended state data for a set of options that configure the draft forum-message.

6. The computer-readable medium of claim 2 where storing the forum-message metadata comprises storing subject data describing an intended subject for the draft forum-message.

7. The computer-readable medium of claim 1 where storing the draft forum-message data comprises storing poll data.

8. The computer-readable medium of claim 1 where the set of collaborating entities to whom the drafting entity seeks to grant edit privileges for the draft forum-message includes the drafting entity.

9. The computer-readable medium of claim 1 comprising:
receiving a draft selection signal from a requesting entity, the draft selection signal identifying a selected draft forum-message; and
providing a portion of the selected draft forum-message to the requesting entity upon determining that draft forum-message data that includes the selected draft forum-message identifies the requesting entity as a collaborating entity having edit privileges for the draft forum-message.

10. The computer-readable medium of claim 9 comprising:
receiving a draft modification signal from the requesting entity, the draft modification signal identifying a modified draft forum-message; and
storing modified draft forum-message data in the data store, the modified draft forum-message data comprising the modified draft forum-message.

11. The computer-readable medium of claim 1 comprising:
receiving a draft reply signal, the draft reply signal identifying a draft forum-message; and
storing a draft reply in the data store, the draft reply being contained in the draft reply signal.

12. The computer-readable medium of claim 11 comprising:
receiving-a publish signal, where the publish signal requests that a draft forum-message be published to an active forum; and
posting the draft forum-message to an active forum, where posting the draft forum message includes publishing, based on an instruction in the publish signal, one or more of the draft forum-message, and a reply to the draft forum message.

13. A computer-readable medium storing computer-executable instructions that when executed by a computer cause the computer to perform a method, the method comprising:
receiving a draft selection signal from a requesting entity, the draft selection signal identifying a requested draft forum-message;
analyzing draft forum-message data that includes the requested draft forum-message to determine if the requesting entity is identified as a collaborating entity for the requested draft forum-message; and
providing for editing a portion of the requested draft forum-message to the requesting entity if the requesting entity is determined to be a collaborating entity.

14. The computer-readable medium of claim 13 comprising:
receiving a draft modification signal from the requesting entity, the draft modification signal identifying a modified draft forum-message; and
storing modified draft forum-message data in the data store, the modified draft forum-message data comprising the modified draft forum-message.

15. The computer-readable medium of claim 14 where storing the modified draft forum-message data includes replacing a portion of the requested draft forum-message data in the data store.

16. The computer-readable medium of claim 14, where storing the modified draft forum-message data includes storing the modified draft forum-message data as new draft forum-message data in the data store.

17. The computer-readable medium of claim 13, comprising:
receiving a display drafts request from the requesting entity;
analyzing draft forum-message data in the data store to determine draft forum-messages for which the requesting entity is identified as a collaborating entity; and
providing a list of the determined draft forum-messages to the requesting entity.

18. A system, comprising:
a draft logic to store draft forum-message data from a drafting entity in a data store, where draft forum-message data comprises a draft forum-message and a set of collaborator identifiers that identify collaborating entities that have edit privileges for a corresponding draft forum-message;
a collaborator screening logic to analyze draft forum-message data that includes a requested draft forum-message determine if a requesting entity seeking to access the requested draft forum-message has been identified as a collaborating entity for the requested draft forum-message; and
an edit logic to provide for editing a portion of the requested draft forum-message to the requesting entity that has been determined to be a collaborating entity for the requested draft forum-message by the collaborator screening logic.

19. The system of claim 18 where draft forum-message data comprises forum-message metadata.

20. The-system of claim 19, where forum-message metadata comprises one or more of, destination data describing an intended destination for the draft forum-message, message type data describing an intended type for the draft forum-message, options data describing intended state data for a set of options that configure the draft forum-message, and subject data describing an intended subject for the draft forum-message.

21. The system of claim 18 where the draft forum-message data comprises poll data.

22. The system of claim 18 where the data store is a database table that stores records corresponding to draft forum-message data and where the database table also stores records corresponding to non-draft forum-message data.

23. The system of claim 22 where the database table includes an attribute that identifies a record as corresponding to draft forum-message data.

24. A system, comprising:
means for storing a first set of draft forum-message data received from a drafting entity, the first set of draft forum-message data comprising, a draft forum-message, and a set of collaborator identifiers that identify collaborating entities to whom the drafting entity seeks to grant edit privileges;
means for determining if a requesting entity is identified by a set of draft forum-message data as a collaborating entity; and
means for providing a portion of a second set of draft forum-message data to an editing entity upon determining that the second set of draft forum-message data identifies the editing entity as having edit privileges for the second set of draft forum-message data.
